(19) United States
(12) Patent Application Publication
(10) Pub. No.: US 2021/0294151 A1
(43) Pub. Date: Sep. 23, 2021

(54) DISPLAY AND CONTROL DEVICE FOR A MOTOR VEHICLE

(71) Applicant: Volkswagen Aktiengesellschaft, Wolfsburg (DE)

(72) Inventors: Christoph Rickers, Lehre (DE); Michael Scheible, Flechtorf (DE); Jan Neumann, Königslutter (DE)

(21) Appl. No.: 17/261,534

(22) PCT Filed: Jul. 16, 2019
(86) PCT No.: PCT/EP2019/069066

§ 371 Date: Jan. 19, 2021

(30) Foreign Application Priority Data
Jul. 25, 2018 (DE) 10 2018 212 445.0

(51) Int. Cl. G02F 1/1335; G02F 1/1333

(52) U.S. Cl. CPC G02F 1/133516; G02F 1/13338; B60K 37/02; B60K 2370/1523; B60K 2370/25

(57) ABSTRACT

A display and/or control element, that includes a layer stack having a TFT layer, a liquid crystal cell and a color filter glass, wherein the color filter glass may be arranged on an outer surface of the layer stack. In some configurations, the color filter glass may project laterally from the layer stack.

### RELATED APPLICATIONS

The present application claims priority to International Patent Application PCT/EP2019/069066 to Rickers et al., titled “Display and Control Device for a Motor Vehicle” filed Jul. 16, 2019, which claims priority to German Patent Application No. DE 10 2018 212 445.0 to Rickers et al., filed Jul. 25, 2018, the contents of each being incorporated by reference in their entirety herein.

### BACKGROUND

The present disclosure relates to a display and/or control element for a motor vehicle.

Dashboards in passenger cars or other motor vehicles are equipped with numerous display instruments (e.g. tachometers with mileage counters, tachometers, coolant temperature and fuel gauges, a clock, direction indicator lamps, an oil gauge, a battery gauge, high beams, etc.) display and control elements (e.g. switches for vehicle lighting, warning lights, or rear window defroster, sliders or switches for controlling the temperature and air distribution in a ventilation system, etc.) and vents in the front part of the motor vehicle for the ventilation system.

The known display devices are usually liquid crystal displays.

The space needed for the information that is to be displayed in multifunctional displays can change constantly, depending on the functional devices and specific functions for which output contents are to be displayed.

FIG. 1 shows a typical sequence and the components necessary for a display and control element. Starting from the bottom, there are a rear light, the so-called back light, comprising LEDs, fiber optics, diffusors, reflectors, and recycling films, followed by a gap. This is followed by a layer functioning as a thin film transistor (TFT). This TFT layer, or TFT glass, comprises the electrode structures, wiring, and the thin layer electronics for activating the individual pixels, collectively forming a multi-component system, in particular a multilayer system. A first linear polarization filter (polarizing filter) is applied to the undersurface of the TFT layer (a polarization filter rotated 90° with respect to its polarization direction is placed as an “upper” polarizing filter on the color filter glass. This embodiment is also known as normal black. Alternatively, both polarizing filters can have the same orientation, referred to as normal white). The TFT layer houses not only the thin film electronics, but also the associated control technology in the form of driver ICs (gate/source) for activating the pixel switching circuits. The color filter glass is call this because it contains color filters for the RGB sub-pixels in each pixel. Depending on the requirements, the outer surface of the cover glass may also have coatings that optimize the optical characteristics thereof, e.g. anti-glare, and/low reflection, anti-fingerprint, or easy to clean coatings.

The color filter glass, TFT glass, and a suitable lateral frame form a cell filled with liquid crystals between the panes.

A touch sensor is frequently applied to this structure, serving as the actual display, using optical bonding techniques. A cover glass is likewise attached to the touch sensor by means of optical bonding, which forms the outer surface of the display/control element. The cover glass is normally decorated on its undersurface with one or more masks. Various technologies and materials with specific advantages and disadvantages can be used for the numerous components, and the overall system can thus be adapted ideally to its intended use.

The known fundamental structure and the special embodiments have in common that the resulting structure comprises numerous functional layers, the overall thickness of which determines the thickness of the display and/or control element. A thicker display and control element requires more space, which has a negative impact on the possible placement and the appearance thereof in the interior of the motor vehicle. Furthermore, increasing the overall thickness frequently results in an increase in the distance between where an image is formed,

specifically in the upper polarizing filter, and the front surface, in particular the level where the masking is located. An increase in this distance normally has a negative impact for the user. Furthermore, bonding steps are normally critical regarding the formation of mechanical tensions—acting on the display module—that result in artifacts and limitations associated therewith, in particular regarding black homogeneity.

### SUMMARY

An object of the present disclosure is to create a display that is optimized with respect to installation space and production tolerances, as well as durability. In particular, a display and control element is to be created that is thinner, and requires fewer, or no, bonding steps during production.

An aspect of the present disclosure therefore relates to a display and/or control element that has a stack of layers containing a TFT layer and a liquid crystal cell placed on the TFT layer. A color filter glass containing a color filter is then placed on the liquid crystal cell, wherein the color filter glass is located on an outer surface of the display and control element, which delimits the stack of layers. In other words, the color filter glass (the glass containing the color filter) placed on the liquid crystal cell is also the outer layer of the display and/or control element. According to the present disclosure, the color filter glass may be designed such that it at least partially projects laterally over the TFT layer and/or the liquid crystal cell. The color filter glass is arranged in the projecting region such that it borders the layer on the active surface of the display, ideally with a very low tolerance. This means that an important function of the aforementioned front glass, or cover glass, for example the cover for the layer stack normally added to the stack, specifically the masking of components of the stack that should not be visible to the customer, is taken over by the color filter glass. Through the design of the inactive border of the display according to the present disclosure, e.g. a contact surface between the TFT layer and the color filter glass, the color filter glass therefore further covers potential supply and control devices in the TFT layer. The display and/or control element as disclosed herein is substantially thinner than in the prior art, while still having the same level of functionality, and satisfying optical demands, and it contains fewer, or no, bonding layers. Furthermore, the distance from the image formation layers to the front of the structure is minimized. The masking may take place at basically the same level where the images are formed (upper polarizing filter), maximizing the perspective range and minimizing otherwise typical shading through parallax effects.

To improve readability of the present disclosure, the display and/or control element may be referred to below as just a “display element”.

The color filter glass may be functionally designed as the front glass for the display element according to the present disclosure, and forms the outer layer of the layer stack, and faces the user in its intended use.

Glass in this case may include not only silicon compounds, but any amorphous solid, in particular organic and inorganic glasses, thermosetting plastics and thermoplastics.

A lateral protrusion as used herein means that the color filter glass may be wider than the other layers in the layer stack in a least one direction, such that it projects from them laterally. In a top view of the color filter glass, this means that the other layers may be covered by the color filter glass in the relevant area of the color filter glass.

Further examples can be derived from the remaining features specified in the present disclosure.

The various examples of the present disclosure specified in this application may also be combined with one another as long as not otherwise specified.

### BRIEF DESCRIPTION OF THE DRAWINGS

The present disclosure shall be explained below in reference to exemplary embodiments, based on the associated drawings. Therein:

FIG. 1 shows a schematic cross-sectional drawing of a display and control element according to the prior art,

FIG. 2 shows a schematic cross-sectional drawing of a display and control element according to a first embodiment of the present disclosure,

FIG. 3 shows a schematic cross-sectional drawing of a display and control element in a second embodiment of the present disclosure,

FIG. 4 shows a schematic cross-sectional drawing of a display and control element in various embodiments of the present disclosure with respect to the placement of a masking layer,

FIG. 5 shows a schematic cross-sectional drawing of a display and control element in a third embodiment of the present disclosure,

FIG. 6 shows a schematic illustration of a display and control element in a top view of another exemplary embodiment, and

FIG. 7 shows a schematic illustration of a display and control element in another exemplary embodiment, in top and lateral cutaway views.

### DETAILED DESCRIPTION

In some examples, color filter glass may include individual color filters that can be spatially assigned to the pixels in the display element. Depending on how the light from a light source behind the TFT layer is deflected through the liquid crystal cell, these color filters generate a defined color. They preferably include the colors red, green, and blue, the so-called RGB colors, because it is possible to generate every other color with these colors, such that other colors, e.g. white or yellow, can also be generated.

Possible designs for the liquid crystal cell are known to the person skilled in the art, as are the manners in which they are filled, e.g. through the ODF method described in brief below.

Liquid crystal cells are normally filled prior to mounting the cells on the lower glass plate. This technology is referred to as “one drop filling” (ODF) technology, and enables a very precise dosing of the liquid crystal amounts. The sealant is applied via capillary effects, unlike with conventional filling methods, such that it completely surrounds the display region. The enclosed region is subsequently filled by means of PDF, and after the subsequent joining of the two glass plates, the bonding agent is cured. This bonding agent is formed by a polymer layer, for example, that can be cured thermally and/or optically. Alternative filling methods are also known.

In some examples, the color filter glass functioning as the cover glass may be configured directly adjacent to the liquid crystal cell, in particular forming a boundary layer, such that an adhesive layer is advantageously unnecessary. As a result, an additional functional layer that would increase the thickness of the display element is eliminated in this region.

It has increasingly been the case that when the display is turned off, a consistent, monochrome black surface is desired, such that the display as such cannot be seen behind the cover glass. This is referred to as a black panel or dead front effect. Because the active display surface is normally a more or less different color than the masking layer or coating, measures are preferred that are suitable for further minimizing these slight differences.

A polarizing filter may be advantageously applied to the outer surface of the cover glass that extends over the entire outer surface. This only allows about one half of the incident light through, reduces the overall brightness of the structure in ambient light, and thus reduces the visibility of the differences.

Accordingly, in some examples, an upper polarizing filter may be applied to the outside of the cover/color filter glass, in order to therefore obtain the dead front effect while also reducing the number of necessary components. This is shown by way of example in FIG. 2.

A similar approach for obtaining these effects is based on the use of a tinted cover glass. Transmittances of at least 50% are preferred for this, for technical reasons. To the same extent that transparency from outside is reduced by tinting, this reduction in transmittance also reduces the passage of the light emitted by the display, e.g. via backlighting. This means that in order to obtain the same brightness in the display for the customer, the brightness of the backlight must be doubled. This involves higher costs and additional heat emissions. The use of the upper polarizing filter, or a corresponding linear polarizing filter parallel thereto, prevents this, because the (linearly polarized) light from the display can pass through it unobstructed, while only 50% of the statistically polarized ambient light can pass through it.

Other configurations are contemplated in the present disclosure for the purpose of making the visible appearance of the display surface resemble regions on the masking layer/coating. These are preferably obtained using a linear polarization filter (polarizing filter) that forms a coating on the color filter glass, or replaces it. The polarizing filter reduces the amount of statistically polarized incident light, and therefore the reflection, further reducing the slight color differences between the display surface and the masked surface, without blocking the light emitted by the display (because they have the same polarization orientations). An alternative, less expensive embodiment variation may include tinting the cover glass material. In this case, however, the light transmittance is reduced to the same extent, requiring an increase in the brightness of the backlight, which has associated disadvantages.

In some examples, the coatings may be applied independently using methods suited to the respective layers. With the masking layer, the layer may be printed onto the color filter layer in one or more layers. Independently of the region where the color filter glass projects over the TFT layer and/or the liquid crystal cell, the masking layer is preferably encompassing, such that in particular most, and preferably all, regions that do not need to remain clear for displaying image contents in the display element, are masked. The masking is particularly advantageously formed such that the masked regions, i.e. those regions that are masked, cannot be distinguished visually from unlit regions in the display element.

The masking is particularly advantageously located on the side of the color filter glass facing the liquid crystal cell, and extends laterally from an encompassing edge of the color filter glass thereto. The liquid crystal cell is preferably sealed at its edges, wherein this seal protrudes in the direction in which the layer stack is stacked, wherein the masking layer extends to the outer edge of the seal in this embodiment of the present disclosure. Alternatively, the masking layer extends into a region between the seal and the color filter glass, and extends to the (inner) edge of the liquid crystal cell.

In the latter case it is ensured that the seal itself is also covered by the masking layer. In some examples, the seal may be colored, such that it gives a color impression that is similar to that of the masking layer.

In the present case, the seal can also be described or understood as a lateral cell wall in the liquid crystal cell.

In some example, if a polarization filter is configured on the color filter glass, this polarization filter may be applied to the entire surface of the color filter glass. Alternatively, the polarization filter may be placed at least in a region as large as the liquid crystal, such that it completely covers the color filter glass in this region. The advantage here is that, in particular, there is no reason for the polarization filter necessary for the actually active display surface of the display element, depending on the embodiment. In other words, instead of placing the upper polarizing filter on the display, a polarization filter is preferably placed on the color filter glass, displacing the upper display polarizing filter outward. As a result, the polarization filter projects laterally over the masking, thus reinforcing the dead front/black panel effect. The polarization filter is preferably applied to the entire surface of the color filter glass.

The polarization filter is preferably applied as a coating, in particular a film, onto the color filter glass.

In some examples, the masking layer may be broken up into sections, and adjacent to the layer stack, a light source may be located on a side of the color filter glass facing the TFT layer that is configured to emit light into the interruptions in the masking. The interruptions exhibit the shapes of various symbols, in particular. Illuminated elements are normally housed in the region of the masking. Such a configuration makes this possible without any further fundamental changes to the structure. By using the polarization filter on the outer surface of the color filter glass, and/or in the active display region of the display element, a “disappearing effect,” (concealing the other elements in the layer stack) can be obtained in which a backlit symbol or message is not visible, for example, when it is not lit. In addition to or as an alternative to a polarization filter applied to the outside of the color filter glass, it is advantageous to apply a so-called “smoke coating” (a semitransparent lacquer) to the back surface (inside of the component) at the interruptions in the masking in order to optimize or obtain the disappearing effect.

This may be particularly advantageous for the optional warning lights located in this region, but it can also be used for normal lights because of its design. When switched off, the display element according to the present disclosure and the adjacent elements have the appearance of a homogenous surface.

In some examples, in order to enhance visibility through a so-called “lamelar film” (also referred to as an LAF or LCF for Light Control Film) in order to prevent reflections of the lights (search/functional/control lights) in side windows or windshields.

In some examples, the structure may not be configured in the form of a complete film, but instead is printed onto the back surface of the smoke coating. Obtaining an adequate aspect ratio for the application is advantageous in this context, because this enables shading of a larger angular range.

The color filter glass may be curved, particularly in a region projecting over the TFT layer and/or the liquid crystal cell. The inner region, which advantageously corresponds to the region that is the same size as the liquid crystal cell with respect to the producibility and durability of the display element, is preferably planar. This embodiment optically integrates the display element in its location in particular, e.g. in the console in a motor vehicle.

The color filter glass may be configured to have a thickness of 0.25 mm to 3.0 mm. This may mean that it is thicker than the color filter glass in the prior art. The durability of the display element is increased in this embodiment, in particular the front glass, i.e. the outer surface of the layer stack. The color filter glass according to the present disclosure has another function in this embodiment than that of a typical cover or front glass, comprising, in addition to the shading, a reinforcement and mechanical protection for the layer stack.

In order to further safeguard against artifacts caused by mechanical effects to the cell, e.g., caused by pressure applied by fingertips to the touchscreen, it may be advantageous to mechanically reinforce the liquid crystal cell by increasing the number and density of spacers.

In some examples, the color filter glass may be configured to contain a component, or a component located on the color filter glass, that is configured to react electrically to the touch of a user. This component is a so-called “touchscreen.”

Resistor film switch panels, piezoelectric switch panels, and touchscreens based on capacitive sensors belong to the human-machine interfaces may be used in the various examples disclosed herein.

Capacitive sensors and buttons are preferably available as operating units in two fundamental variations, one with mechanical buttons, and one with proximity and touch sensors. “Mechanical” contact is not necessary with this embodiment, because the proximity of the finger already acts on the capacitor. Piezoelectric switches are preferably also provided. Piezoelectricity (pressure electricity) is a property of certain crystalline substances, including natural crystals such as quartz, Rochelle salt, tourmaline, and ceramics such as barium titanate and lead zirconate titanate (PZT). If pressure is applied to these substances, an electrical charge proportional to the pressure is triggered in the crystalline structure. The crystal is then no longer outwardly electrically neutral. On the contrary, when an electrical field is applied, the shape of the crystal or ceramic changes. A stroke of 1 to 10 μm is adequate for generating enough of a charge for the switching procedure. Pressure, instead of a physical distance, is adequate for a switching procedure. This effect can also be used to obtain haptic feedback, e.g. in response to an input.

Alternatively, the control panel in the display element according to the present disclosure for obtaining a touch-sensor contains a so-called “optical sensor system,” in which a grid comprised of IR radiation is formed in front of the display, such that the location of a touch is determined by detecting interruptions in the grid (e.g. by the finger). One advantage with this method is the unlimited functioning, even with thick gloves, arbitrary materials, or pens, because only the interruption of the light beams matters.

The touch sensors or proximity switches, in contrast, function without contact, and do not become worn. Any conductive or non-conductive object in the vicinity will affect the capacitance of the electrode. The touch electrode can be placed behind an insulating layer (usually glass or plastic). A keypad protected against environmental effects can thus be easily obtained. The changes in the measured capacitances or charges are assessed by a microcontroller. The assessment usually takes place on the basis of the known charge transfer principle.

Because the goal of the display element according to the present disclosure is to reduce the layer thickness, it is particularly preferred if the (touch) control element is a so-called “InCell-Touch,” wherein the touch sensor with both sensor layers is located in the liquid crystal cell, in that the electrode structures for activating the cell during pulse pauses are used as sensors, or suitable additional structures are placed in the TFT layer. Alternatively, the operating element is formed by a so-called “OnCell Touch,” wherein the touch sensor is placed directly on the liquid crystal cell, such that no additional sensor glass is necessary. Because the cover glass for the liquid crystal cell also forms the cover glass according to the present disclosure, in this specific case an OnCell-Touch corresponds to a so-called “OGS” (One Glass Solution) in which the sensor structure is placed directly on the cover glass, without an additional “sensor glass.” The sensor structure can be formed here on the inner, outer, or both sides of the cover/color filter glass. If the structures are on the outside, the polarizing filter applied according to the present disclosure to the outside also acts as a safeguard with respect to the appearance and possible damage to the structures.

In some examples, an alternative configuration may be formed by the placement of the touch operating element next to the color filter glass, wherein a surface of the touch operating element facing the TFT layer and the color filter glass are flush to one another. In this example, the color filter glass does not project over the TFT layer on the side facing the touch operating element. Instead, it is preferred that the TFT layer is wider than the color filter glass on this side, or in this region of the layer stack.

As explained above, the TFT layer may be electrically activated via a control unit. The control unit may include a so-called “driver,” which is electrically connected to the TFT layer and the microelectronics contained therein. The control unit, or the driver, which is located on a chip, is relatively close to active surfaces in conventional cells, in particular in an edge section, on the TFT layer itself. This is achieved in that the TFT layer in this region projects laterally beyond this layer stack (except for the cover/color filter glass).

In the display element according to the present disclosure, the thickness of the layer stack may be reduced such that an assembly of this type is difficult to obtain. As a result, it is preferred that the TFT layer is connected electrically, for example via a flexible wire, to the control unit, which may be located within the layer stack, for example, adjacent to the TFT layer and/or active surfaces in the display element, or outside the layer stack. This is preferably achieved via a so-called “Chip-on-foil” (COF) solution, in which the chip for the driver is attached to a film, and connected to the TFT layer via flexible wires. The chip is then preferably located outside the layer stack, or placed vertically next to it.

Alternately or in addition, the driver may be configured to be thinner than known models and/or is still placed on the TFT layer. In order to allow for the thickness (of the driver) in the latter configuration, the TFT layer has a recess in a region outside the projection surface of the liquid crystal cell on the TFT layer, formed by etching, for example, and having a surface that at least corresponds to the surface area of the driver or the chip. The chip is then placed within this recess and in electrical contact with the TFT layer.

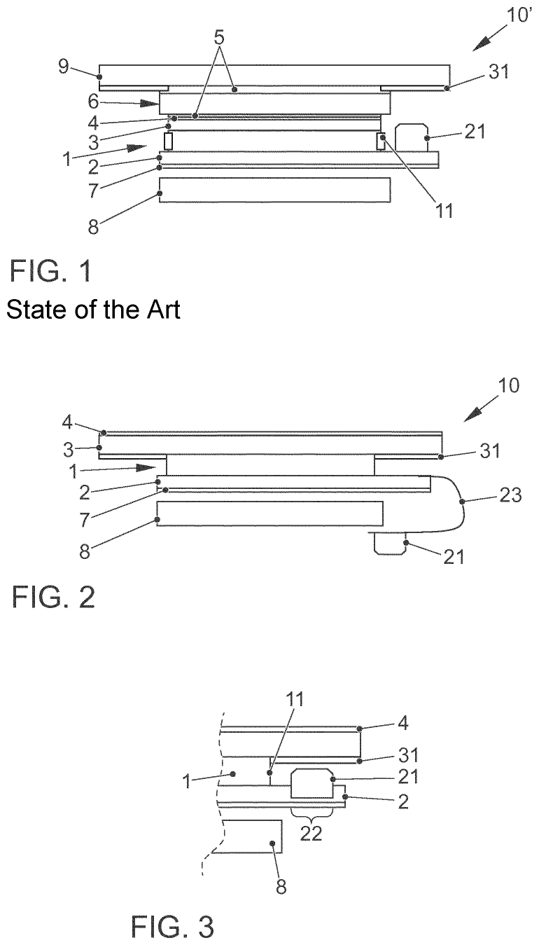

FIG. 1 shows the typical construction of a display and control element 10′ according to the prior art. Such an element typically comprises numerous successive functional layers aligned with one another. The central layer forms a liquid crystal module, or a liquid crystal cell.

A liquid crystal module (LCM) or cell comprises two glass plates with a liquid crystal material therebetween. The opening via which the liquid crystal material is placed between the glass plates is closed by means of a sealing layer 11. A polarization filter 4 is applied to at least one of the glass plates. A second polarization filter 7, preferably rotated 90° to the first, is placed on a side of the liquid crystal cell lying opposite the first. A color filter glass 3 is also placed on one of the two glass plates, preferably the upper. This is configured such that 3 sub-pixels in red, green and blue are obtained in each pixel by means of the light passing through the liquid crystal cell 1 on a side of the color filter glass facing away from the liquid crystal cell 1.

A TFT layer 2 is connected to a control unit comprising a driver 21 on the TFT layer 2, and corresponding signal lines on a side of the liquid crystal cell 1 lying opposite the color filter glass 3 via the driver 21 and the TFT layer 2. The control unit activates individual pixels. Activation is understood here to mean applying a voltage, which aligns an IPS cell in the liquid crystal above or between the electrodes in order to obtain the desired transparency in a non-limiting example. The driver 21, a transistor driver, is a circuit that provides the electricity necessary to switch a transistor on or off within the required time. This is usually a gain with an additional level converter. This makes it possible to connect large loads with MOSFETs or IGBTs to a logic output. This driver can be analog (linear) or digital.

The light passing through is obtained from the backlight 8, a so-called “Backlight Unit” (BLU) 8, normally comprising a reflector, a waveguide, diffusors, beam-shaping films, recycling films, and potentially lamellar films and LED(s). BLUs are obtained in various forms, e.g., as side- or edge-lit (in which LEDs are placed at the edge, and project light laterally inward) or as a matrix backlight (LEDs are distributed behind the display surface and provide a better dynamic contrast through coordinated activation thereof).

When used in a motor vehicle, e.g., as a climate control element or the like, a conventional display and control element 10′ also comprises a cover or front glass 9 (cover), which is frequently designed to obtain various optical surface effects in the display and control element, e.g., anti-glare effects, anti-reflection, anti-fingerprint, easy-to-clean, etc., as well as to obtain the general design of the display element.

The cover glass 9 is larger than the rest of the layer stack, and has a masking 31—normally black. Cover glasses are increasing not exclusively flat or planar, but instead are curved in regions to fit the environment. The masking either extends to the active surface of the display and control element 10′, taking positioning tolerances into account, or it extends slightly over this active surface. The active surface of the display and control element 10′ corresponds to the region in which the TFT layer 2, the liquid crystal cell 1, the polarizers 4, 7, and the color filter glass 3 overlap. In the present case, an active surface is understood to be the region of the display element that has pixels that can be activated. Adjacent to this is normally an edge region, which does not substantially differ optically from the display element when it is shut off, and which may be visible. In some devices, warning lamps/message lamps are integrated in the masking 31, which may be concealed by further translucent coatings when shut off. In both cases, the masking 31 functions as a mask and/or template for the backlight 8, such that various symbols (e.g., blinkers, warning lights, parking brakes, etc.) can be depicted. Furthermore, sensor surfaces form buttons in a display control unit. In this case, the touch sensor is expanded accordingly and adapted to the touch layout, or additional touch sensors are obtained. In this case, a touch structure in front of the display is read by another electronics system than that under sensor buttons. The two structures are then electrically independent of one another.

All of the aforementioned components 1-7 are normally bonded optically to one another, and not infrequently provided by different distributers.

FIGS. 2 to 5 and 7B each show a display and control element 10 in the same manner and with the same functions as described above in reference to various examples of the present disclosure.

In these examples, a TFT layer 2 may be placed on the liquid crystal cell 1. The TFT layer 2 may be connected to the control unit to activate or control the TFT layer 2. The driver 21 in the control unit comprises a chip, which is placed on a separate component, e.g., a film or a plate, as shown in FIG. 2, and may be connected to the TFT layer via a flexible wire 23. An alternative to this is shown in FIG. 3. In FIG. 3, the driver 21 may be placed directly on the TFT layer. The driver 21 may be advantageously placed in a recess or cavity in the TFT layer 2.

The backlight 8 may be placed on a side of the TFT layer 2 facing away from the liquid crystal cell 1, at a distance thereto.

In some examples, the liquid crystal cell 1 is delimited at a side facing away from the TFT layer by the color filter glass 3. The color filter glass 3 may be wider than the underlying layers. It therefore projects over the layer stack, and extends laterally in particular over the liquid crystal cell 1 and at least portions of the TFT layer 2.

In the embodiments shown herein, the color filter glass 3 also has a masking layer 31. This is placed in the region projecting over the liquid crystal cell 1 on a side of the color filter glass 3 facing the liquid crystal cell 1.

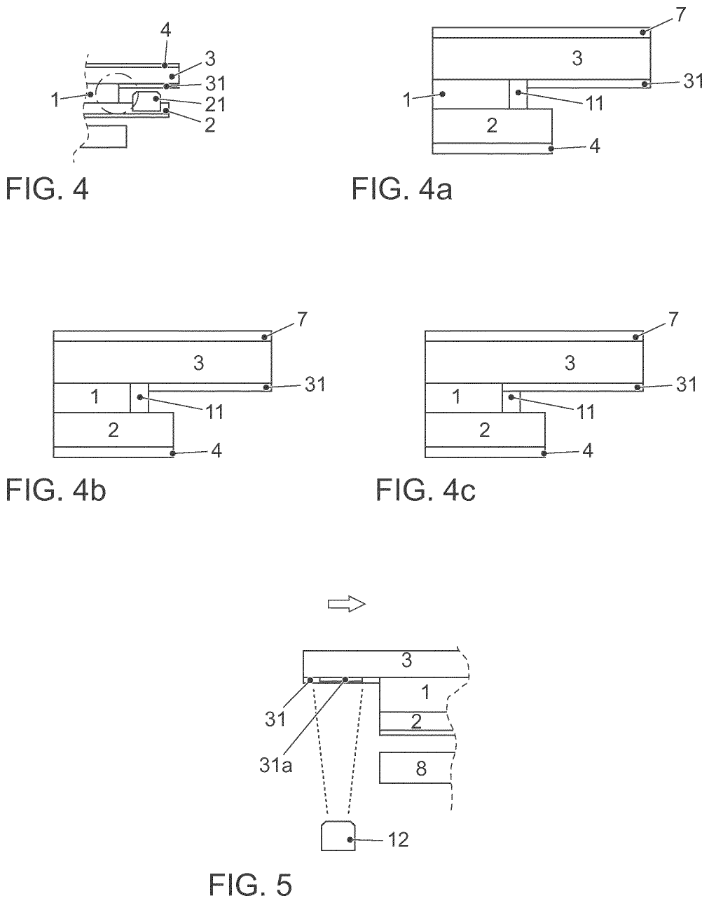

FIG. 4 shows an example of a layout of the masking layer 31 on the color filter glass in greater detail.

FIG. 4a shows an enlargement of a variation in which the masking layer 31 extends laterally to the seal 11 of the liquid crystal cell 1. It is tinted in this example, such that it presents a uniform image to the user in its intended use, as the transitions and borders of the components comprising the layer stack are not visible through the color filter glass 3 from the side facing away from the layer stack. An alternative is shown in FIG. 4b in which the masking layer 31 extends laterally to the seal 11, without additional measures such as a tinting being carried out during production. As a result, the seal 11 can be shorter, wherein the masking layer 31 also serves as a seal for the liquid crystal cell. Alternatively, the seal 11 can be compressed, and is compressed as far away from the masking layer 31 as necessary when the masking layer 31 is placed on the liquid crystal cell 1. In both cases it may be advantageous if the masking layer 31 is first placed on the color filter glass 3, prior to placing the color filter glass 3 on the liquid crystal cell 1.

The color filter glass 3 itself is preferably made of a transparent, solid, less ductile material, e.g., glass, acrylic glass, thermoplastics, and/or thermosetting plastics, etc. These can be shaped as desired by means of film injection molding, casting, injection molding, etc. The same is the case for the other materials in the liquid crystal cell 1. Furthermore, the color filter glass can be a composite glass comprising numerous identical or different materials.

FIG. 4c shows an embodiment in which the masking layer 31 at least partially overlaps the seal 11. Variations of this are conceivable in which the masking extends further into the region of the liquid crystal cell 1 than shown here.

The masking layer 31 is preferably printed, painted, or sprayed onto the color filter glass 3, or applied by means of immersion, wherein in this latter case, a removable negative template is first placed on the surface of the color filter glass 3.

The masking layer 31 can also form a coating applied by a vacuum process, if this is necessary, e.g. as is the case in FIG. 4, in order to ensure the necessary sealing of the liquid crystal cell 1, and/or to obtain the necessary heat resistance in the masking layer 31 needed for applying a touch sensor.

In another variation, the masking layer 31 can be applied, in particular as a black surface, e.g., applied by means of sputtering, CVD, etc., only locally, and not over the entire surface, surrounding the active surface of the display element 10, in particular when, in combination with a continuous upper polarization filter 7, an adequate shading effect is to be obtained, and the masking layer 31 mainly serves as the shaping boundary for displays (see FIG. 5).

Illuminated elements may be placed in the region of the masking layer 31. This is also possible in the display element 10 according to the present disclosure, without any fundamental change to the structure, as shown by way of example in FIG. 5. By using the upper polarization filter 7 on the outer surface of the color filter layer 3, a shading effect, also referred to as a “disappearing effect,” can be readily obtained in which a backlit symbol or display is not visible when it is not lit. This is essential for warning lights, but is also increasingly used for normal lights, because of the design. When switched off, the display element 10 and the adjacent elements have the appearance of a continuous homogenous surface.

To increase the functionality of the cover glass, which also functions as reinforcement, the color filter glass 3 is preferably thicker than normal. By way of example, the color filter glass 3 is preferably 0.5 to 3 mm, in particular 0.5 to 2 mm, thick in the display element according to the present disclosure, instead of the normal 0.25-1.0 mm.

For some applications in the automotive industry, a head impact test must be passed. This is fundamentally already the case, because the upper polarization filter 7 is placed on the side of the color filter glass 3 facing away from the liquid crystal cell 1. In order to increase the reinforcement effect, the polarization filter 7 on the color filter glass 3 can be thicker and/or formed on a suitable film substrate. Alternatively or additionally, an additional film can be placed on and/or under the upper polarization filter 7.

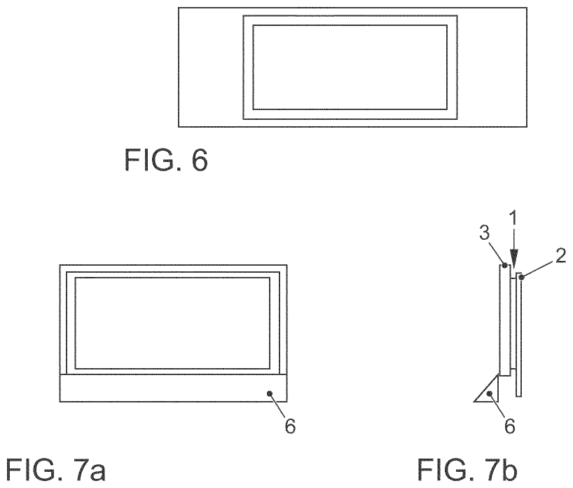

In addition to the variations explained so far, in which the color filter glass 3 is wider laterally than the TFT layer 2, variations in which the TFT layer 2 is wider than the color filter glass 3 on one or more sides of the layer stack are also conceivable, e.g. when the display function of the display element 10 has a space for a touch sensor, e.g. in the form of a so-called “touch-slider,” or some other input element, which transitions to the display element 10 seamlessly (see FIG. 6).

### LIST OF REFERENCE SYMBOLS

10 display and/or control element
10′ display and/or control element according to the prior art
1 liquid crystal cell
11 seal
2 TFT layer
21 driver or driver-IC
23 flexible wiring
3 color filter glass
31 masking layer
4, 7 polarization filter
5 bond
6 touchscreen
8 backlight
9 front glass

1-9. (canceled)

10. A layer stack for a display and/or control element comprising:
a thin film transistor (TFT) layer;
a liquid crystal cell configured on the TFT layer; and
a color filter glass comprising a color filter, delimiting the liquid crystal cell on a side facing away from the TFT layer, wherein the color filter glass is configured on an outer surface of the display and/or control element,
wherein the color filter glass projects laterally in a region at least partially over the TFT layer and/or the liquid crystal cell, and wherein the color filter glass is configured to conceal at least a portion of the layer stack in a projecting region.

11. The layer stack of claim 10, wherein the region projecting laterally is configured with reduced transparency through a masking layer applied thereto.

12. The layer stack of claim 11, wherein the masking layer is configured on a side of the color filter glass facing the liquid crystal cell, and extending from an encompassing edge of the color filter glass to an edge of a seal for the liquid crystal cell extending in the stacking direction of the layer stack,

13. The layer stack of claim 11, wherein the masking layer is configured on a side of the color filter glass facing the liquid crystal cell, and extending from an encompassing edge of the color filter glass into a region between a seal for the liquid crystal cell and the color filter glass.

14. The layer stack of claim 13, wherein the seal is colored.

15. The layer stack of claim 11, wherein the masking layer comprises a plurality of sections, and a light source is located next to a layer stack on a side of the color filter glass facing the TFT layer, which is configured to emit light into interruptions in the masking.

16. The layer stack of claim 10, wherein the color filter glass comprises a polarization filter, covering at least a portion of the surface of the color filter glass.

17. The layer stack of claim 10, wherein at least portions of the color filter glass are curved.

18. The layer stack of claim 10, wherein the color filter glass is 0.5 mm to 3 mm thick.

19. The layer stack of claim 10, wherein the color filter glass comprises a component located on the color filter glass configured to react electrically to the touch of a user.

20. The layer stack of claim 10, wherein the TFT layer is connected electrically to a control unit located adjacent to the TFT layer, or outside the layer stack.

21. A method of forming a layer stack for a display and/or control element comprising:
providing a thin film transistor (TFT) layer;
providing a liquid crystal cell configured on the TFT layer; and
providing a color filter glass comprising a color filter, delimiting the liquid crystal cell on a side facing away from the TFT layer, wherein the color filter glass is configured on an outer surface of the display and/or control element,
wherein providing the color filter glass comprises configuring the color filter glass to project laterally in a region at least partially over the TFT layer and/or the liquid crystal cell, and configuring the color filter glass to conceal at least a portion of the layer stack in a projecting region.

22. The method of claim 10, further comprising configuring the region projecting laterally with reduced transparency through a masking layer applied thereto.

23. The method of claim 11, further comprising configuring the masking layer is on a side of the color filter glass facing the liquid crystal cell, and extending from an encompassing edge of the color filter glass to an edge of a seal for the liquid crystal cell extending in the stacking direction of the layer stack,

24. The method of claim 11, further comprising configuring the masking layer on a side of the color filter glass facing the liquid crystal cell, and extending from an encompassing edge of the color filter glass into a region between a seal for the liquid crystal cell and the color filter glass.

25. The method of claim 13, wherein the seal is colored.

26. The method of claim 11, wherein the masking layer comprises a plurality of sections, and a light source is located next to a layer stack on a side of the color filter glass facing the TFT layer, which is configured to emit light into interruptions in the masking.

27. The method of claim 10, wherein the color filter glass comprises a polarization filter, covering at least a portion of the surface of the color filter glass.

28. The method of claim 10, wherein at least portions of the color filter glass are curved.

29. A layer stack for a display and/or control element comprising:
a thin film transistor (TFT) layer;
a liquid crystal cell configured on the TFT layer; and
a color filter glass comprising a color filter, delimiting the liquid crystal cell on a side facing away from the TFT layer, wherein the color filter glass is configured on an outer surface of the display and/or control element,
wherein the color filter glass projects laterally in a region at least partially over the TFT layer and/or the liquid crystal cell, and wherein the color filter glass is configured to conceal at least a portion of the layer stack in a projecting region, and wherein the color filter glass comprises a component located on the color filter glass configured to react electrically to the touch of a user.
